(19) United States
(12) Patent Application Publication
(10) Pub. No.: US 2015/0277811 A1
(43) Pub. Date: Oct. 1, 2015

(54) METHOD FOR CONFIGURING INFORMATION RELATED TO A 3D PRINTER AND METHOD AND APPARATUS FOR RECOMMENDING A 3D PRINTER

(71) Applicant: Electronics and Telecommunications Research Institute, Daejeon (KR)

(72) Inventors: Seung-Wook LEE, Daejeon (KR); Kap-Kee KIM, Daejeon (KR); Jin-Sung CHOI, Daejeon (KR)

(21) Appl. No.: 14/670,968

(22) Filed: Mar. 27, 2015

(30) Foreign Application Priority Data
Mar. 27, 2014 (KR) 10-2014-0036275
Mar. 9, 2015 (KR) 10-2015-0032789

(51) Int. Cl. G06F 3/12

(52) U.S. Cl. CPC G06F 3/126; G06F 3/1203

(57) ABSTRACT

Exemplary embodiments of the present invention provide optimized 3D printings to a user by inserting metadata (i.e., a current model should be printed with a strong heat resistance material) to a 3D object for 3D printing and combining preference of a default printing material which a user desires (i.e., since glass is fragile, it does not like to print with glass) based thereon and printer performance of the user's (i.e., the printer which can print glass and plastic).

### CROSS REFERENCE TO RELATED APPLICATION

This application claims the benefit of Korean Patent Application No. 10-2014-0036275, filed on Mar. 27, 2014, entitled “A method and device for providing additional information for intelligent engine in the cloud 3D printing” and Korean Patent Application No. 10-2015-0032789, filed on Mar. 9, 2015, entitled “Method for configuring information related to 3D printer and method and apparatus for recommending 3D printer”, which are hereby incorporated by reference in its entirety into this application.

### BACKGROUND

1. Technical Field

Exemplary embodiments of the present invention relate to a method for configuring information related to a 3D printer and a method and apparatus for recommending a 3D printer.

2. Description of the Related Art

Materials which are currently used for 3D (three dimensions or three dimensional) printing are very diverse, for example, plastics, metals, rubbers, ceramics, bio-materials and foods, etc. Even though materials are the same kinds, their properties such as heat resistance, durability and cold resistance, etc. are different each other. Further, materials which can be used vary with the kinds of 3D printer. It is thus difficult to choose an appropriate material among various materials when a user wants to print a 3D object.

The international standardization currently has a tendency to standardize metadata which can control a variety of devices.

### SUMMARY

Exemplary embodiments of the present invention provide a method for recommending a 3D printer which is appropriate to a user.

Exemplary embodiments of the present invention provide a method for recommending a 3D printer which satisfies user's preference.

A method for configuring information related to a 3D printer according to an embodiment of the present invention includes configuring user's preference information which is used to print a 3D object or select a 3D printer; and configuring characteristic information of a 3D printer which prints the 3D object.

In an embodiment of the present invention, the user preference information may include at least one information of printing material, physical properties of a printing material, printing size, printing price, delivery time of a printed result, surface thickness of a printed result, and information whether size and material information included in a 3D model is to be used or not.

In an embodiment of the present invention, the printer characteristic information may include at least one information of 3D printer specification, material/color/file supportable by a 3D printer, maximum size of an object that can be printed by a 3D printer, resolution of a 3D printer and accuracy of a 3D printer.

A method for recommending a 3D printer according to an embodiment of the present invention includes receiving user's preference information which is used to print a 3D object; selecting a 3D printer which satisfies the user's preference information by referring to a database storing characteristic information of at least one 3D printer; and recommending the selected 3D printer to the user.

In an embodiment of the present invention, the user's preference information may be received with a 3D model which is used to print the 3D object.

In an embodiment of the present invention, the 3D model may include at least one of size and material information of the 3D object.

In an embodiment of the present invention, the material information of the 3D object may include at least one of material characteristic information and material type information.

In an embodiment of the present invention, the user preference information may include at least one information of printing material, physical properties of a printing material, printing size, printing price, delivery time of a printed result, surface thickness of a printed result, and information whether size and material information included in a 3D model is to be used or not.

In an embodiment of the present invention, the 3D model may include at least one of size and material information of the 3D object, and if the user preference information indicates not to use the size and material information included in the 3D model, size and material information included in the user preference information is used when the 3D printer is selected.

In an embodiment of the present invention, the 3D model may include at least one of size and material information of the 3D object, and if the user preference information indicates to use the size and material information included in the 3D model, size and material information included in the 3D model is used when the 3D printer is selected.

In an embodiment of the present invention, the printer characteristic information may include at least one information of 3D printer specification, material/color/file supportable by a 3D printer, maximum size of an object that can be printed by a 3D printer, resolution of a 3D printer and accuracy of a 3D printer.

An apparatus for recommending a 3D printer according to an embodiment of the present invention may include a communication unit configured to receive user's preference information which is used to print a 3D object; a database configured to store characteristic information of at least one 3D printer; and a recommendation engine configured to select a 3D printer which satisfies the user's preference information by referring to the database and recommending the selected 3D printer to the user.

According to exemplary embodiments of the present invention, it allows to print a 3D object through the 3D printer which satisfies user's preference among a plurality of printers existing in cloud.

According to exemplary embodiments of the present invention, information appropriate to print a 3D object may be configured as metadata of a 3D model.

According to exemplary embodiments of the present invention, it allows to print a 3D object by using the printing material which satisfies user's preference the most.

### BRIEF DESCRIPTION OF DRAWING

FIG. 1 is an exemplary view illustrating the concept of a method for recommending a 3D printer according to an embodiment of the present invention.

FIG. 2A, FIG. 2B, FIG. 2C and FIG. 2D illustrate XML schema specifying preference information defined in Table 1 and Table 2.

FIG. 3A, FIG. 3B and FIG. 3C illustrate CS (classification scheme) specifying printing material characteristic information which is used to print a 3D object.

FIG. 4A, FIG. 4B, FIG. 4C and FIG. 4D illustrate CS (classification scheme) specifying material type information which is used to print a 3D object.

FIG. 5 illustrates preference information written in the XML format according to an embodiment of the present invention.

FIG. 6A, FIG. 6B, FIG. 6C and FIG. 6D illustrate XML schema specifying printer characteristic information defined in Table 3 to Table 5.

FIG. 7 illustrates CS (classification scheme) of supported file formats from the 3D printer characteristic information.

FIG. 8A and FIG. 8B illustrate CS of the printer type.

FIG. 9A, FIG. 9B, FIG. 9C, FIG. 9D, FIG. 9E, FIG. 9F, FIG. 9G, FIG. 9H, FIG. 9I and FIG. 9J illustrate CS of specific elements of a powder-typed printing material.

FIG. 10 illustrates printer characteristic information written in the XML format according to an embodiment of the present invention.

FIG. 11 is a flowchart illustrating a method for recommending a 3D printer according to an embodiment of the present invention.

FIG. 12 is a block view illustrating an apparatus for recommending a 3D printer according to an embodiment of the present invention.

### DESCRIPTION OF THE EXEMPLARY EMBODIMENTS

The above and other objects, features and advantages of the present invention will become more apparent to those of ordinary skill in the art by describing in detail exemplary embodiments thereof with reference to the accompanying drawings. Throughout the description of the present invention, when describing a certain technology is determined to evade the point of the present invention, the pertinent detailed description will be omitted.

Exemplary embodiments of the present invention provide a method for configuring information related to a 3D printer.

The information related to a 3D printer may include user's preference information and printer characteristic information. The user preference information may be used to print a 3D object or select 3D printer.

Exemplary embodiments of the present invention provide a method for recommending a printer which satisfies user's preference information.

In the description of exemplary embodiments of the present invention hereinafter, it is described for a 3D printer but they may be applied to a 2D printer.

The 3D object in exemplary embodiments of the present invention herein means results printed or to be printed based on a 3D model.

The present invention will be explained in more detail below with reference to the accompanying drawings.

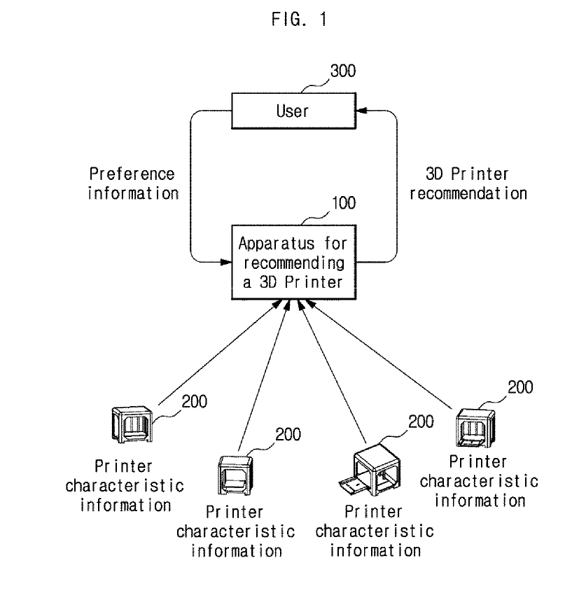

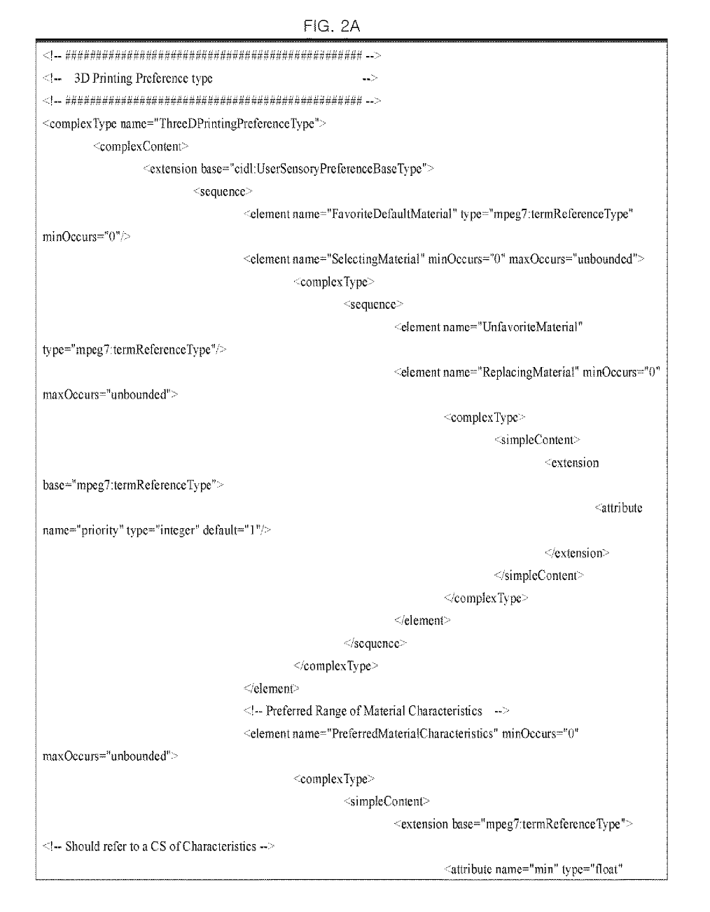

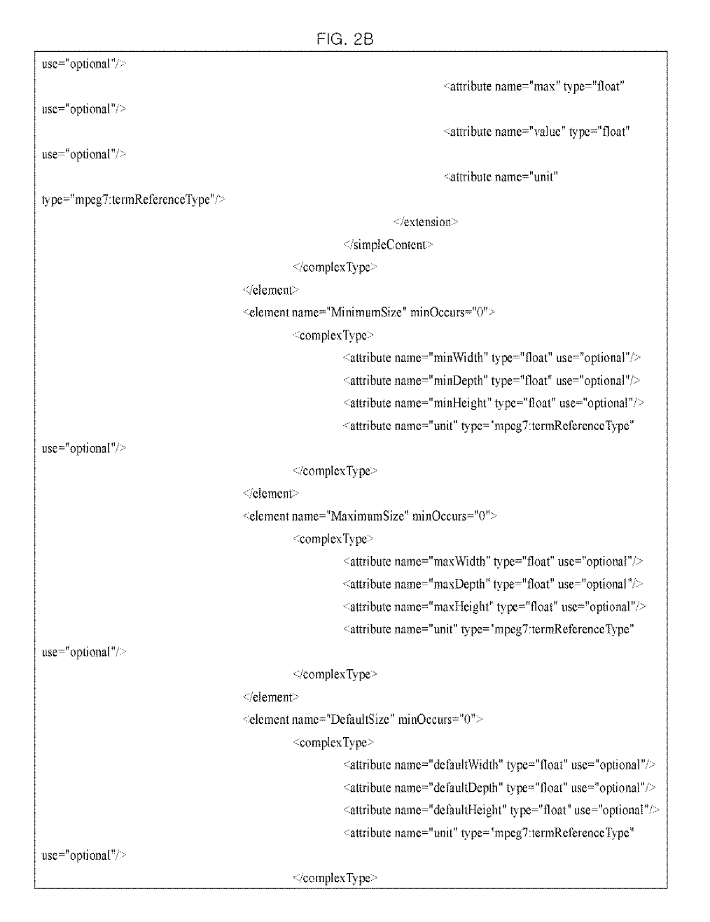

FIG. 1 is an exemplary view illustrating the concept of a method for recommending a 3D printer according to an embodiment of the present invention.

An apparatus for recommending a 3D printer 100 may receive printer characteristic information of corresponding 3D printers 200 from a plurality of 3D printers 200 existing in cloud and further store the received printer characteristic information.

The apparatus for recommending a 3D printer 100 may receive preference information to be used to print a 3D object from a user 300. The apparatus for recommending a 3D printer 100 may determine whether there is printer characteristic information which satisfies the user's preference information by comparing the printer characteristic information stored by itself with the preference information received from the user 300.

When there is printer characteristic information which satisfies the user's preference information, the apparatus for recommending a 3D printer 100 may provide the printer information corresponding to the printer characteristic information to the user 300. That is, the apparatus for recommending a 3D printer 100 may recommend the 3D printer which satisfies the preference information to the user 300.

In an embodiment of the present invention, the preference information may include at least one information of printing material, physical properties of a printing material, printing size, printing price, delivery time of a printed result (3D object), surface thickness of a printed result, and information whether size and material information included in a 3D model is to be used or not.

In an embodiment of the present invention, if the user's preference information indicates not to use the size and material information included in the 3D model, size and material information included in the user preference information may be used when the 3D printer is selected.

In an embodiment of the present invention, if the user preference information indicates to use the size and material information included in the 3D model, size and material information included in the 3D model may be used when the 3D printer is selected. The preference information may be set by a user who wants for 3D printing.

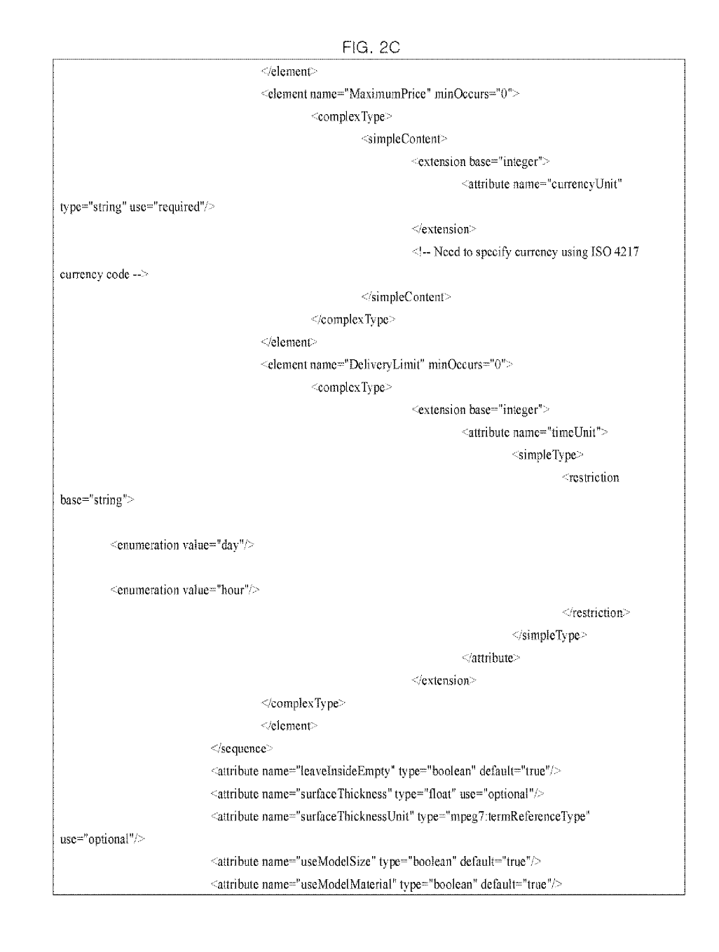

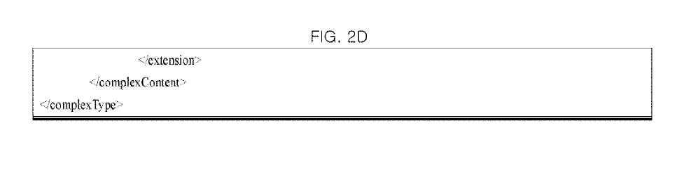

Table 1 and Table 2 are terms related to preference information and definitions thereof. FIG. 2A, FIG. 2B, FIG. 2C and FIG. 2D illustrate XML schema specifying the preference information defined in Table 1 and Table 2.

TABLE 1

| Name | Definition |
|---|---|
| ThreeDPrintingPreferenceType | Tool for describing user's preference on 3D printing. |
| FavoriteDefaultMaterial | Default printing material which a user prefers. |
| | when a specific printing material is not specified, a |
| | classification scheme term defined in MPEG-V |
| | is used. |
| SelectingMaterial | When printing materials which are unfavorite to a |
| | user are defined, list of printing materials to |
| | replace the unfavorite printing materials. |
| Unfavorite Material | Unfavorite printing material. |
| | Defined in a CS term. |
| ReplacingMaterial | Printing materials to replace unfavorite printing |
| | materials. |
| | A plurality of printing materials which can replace |
| | one unfavorite printing material may be possible. |
| | When a plurality of replacing printing material are |
| | available, the material with the highest priority value |
| | is selected. |
| Priority | When a plurality of replacing printing materials are |
| | available for one unfavorite printing material, the |
| | printing material having higher priority is selected. |
| PreferredMaterialCharacteristics | Physical properties which a user desires for a |
| | preferred printing material. |
| min | Minimum value of physical properties. |
| max | Maximum value of physical properties. |
| value | Particular value which is not minimum value nor |
| | maximum value. |
| unit | Unit for physical properties of a preferred printing |
| | material. |
| | Defined in a CS term. |
| MinimumSize | Minimum printing size which a user wants. |
| minWidth | Width among minimum printing sizes which a user |
| | wants. |
| | (for example, length of the X-axis direction on the |
| | three-axis coordinate system) |
| minDepth | Depth among minimum printing sizes which a user |
| | wants. |
| | (for example, length of the Y-axis direction on the |
| | three-axis coordinate system) |
| minHeight | Height among minimum printing sizes which a |
| | user wants. |
| | (for example, length of the Z-axis direction on the |
| | three-axis coordinate system) |
| unit | Unit defining the minimum printing size which a |
| | user wants. |
| MaximumSize | Value defining the maximum printing size which a |
| | user wants. |
| maxWidth | Width among maximum printing sizes which a user |
| | wants. |
| maxDepth | Depth among maximum printing sizes which a |
| | user wants. |
| maxHeight | Height among maximum printing sizes which a |
| | user wants. |
| unit | Unit defining the maximum printing size which a |
| | user wants. |

TABLE 2

| Name | Definition |
|---|---|
| DefaultSize | Default printing size which a user wants. |
| defaultWidth | Width among default printing sizes which a user |
| | wants. |
| defaultDepth | Depth among default printing sizes which a user |
| | wants. |
| defaultHeight | Height among default printing sizes which a user |
| | wants. |
| unit | Unit defining default printing size which a user |
| | wants. |
| MaximumPrice | Maximum price which can be paid for 3D |
| | printing. |
| currencyUnit | Currency unit for 3D printing price. |
| DeliveryLimit | Maximum delivery time of a 3D printed result. |
| timeUnit | Time unit representing maximum delivery time |
| | of a 3D printed result. |
| leavelnsideEmpty | Flag determining whether the inside a 3D printed |
| | result is filled or not. |
| surfaceThickness | Surface thickness when the surface of a 3D |
| | printed result has a thickness. |
| surfaceThicknessUnit | Unit representing the surface thickness. |
| useModelSize | Information representing whether the size |
| | information defined in a 3D model will be used or |
| | not. |
| useModelMaterial | Information representing whether the material |
| | information defined in a 3D model will be used or |
| | not. |

A 3D model may include at least one of size and material information of a 3D object. The information may be inserted in a metadata type to the 3D model. The material information of the 3D object may include at least one of material characteristic information and material type information.

In an embodiment of the present invention, the material characteristic information may include at least one information of tensile, flexural strength, Izod, compression, shear, temperature, volume resistance, dielectricity, dissipation factor, specific gravity, density and hardness.

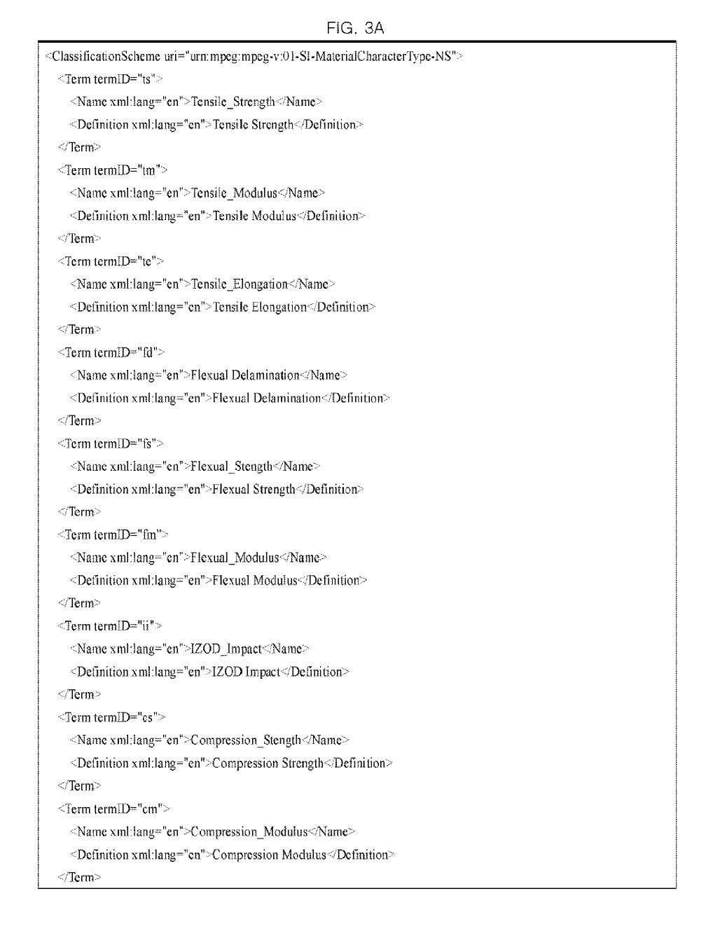

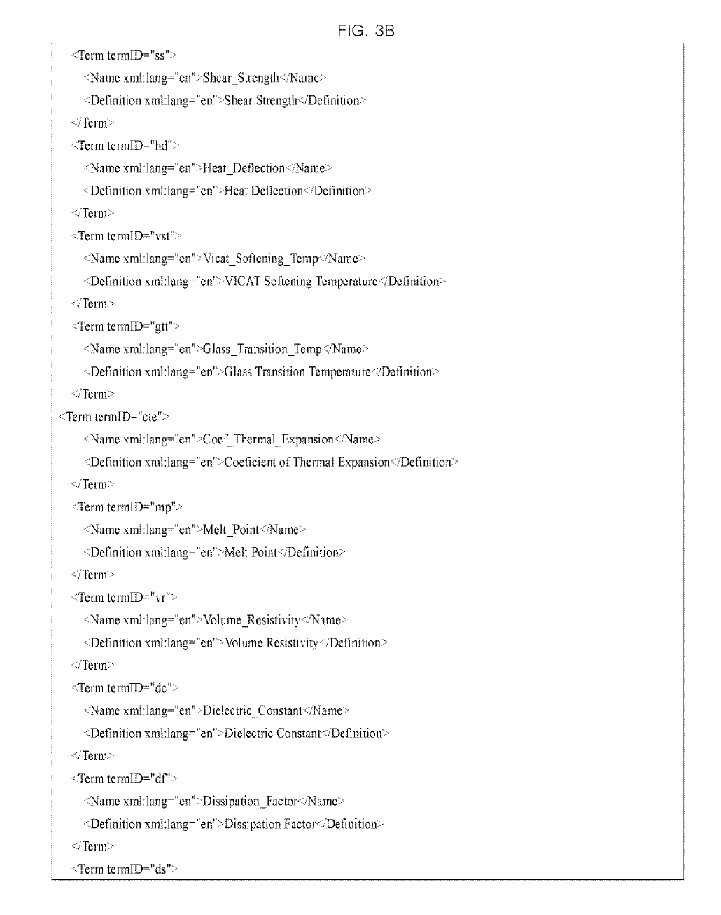

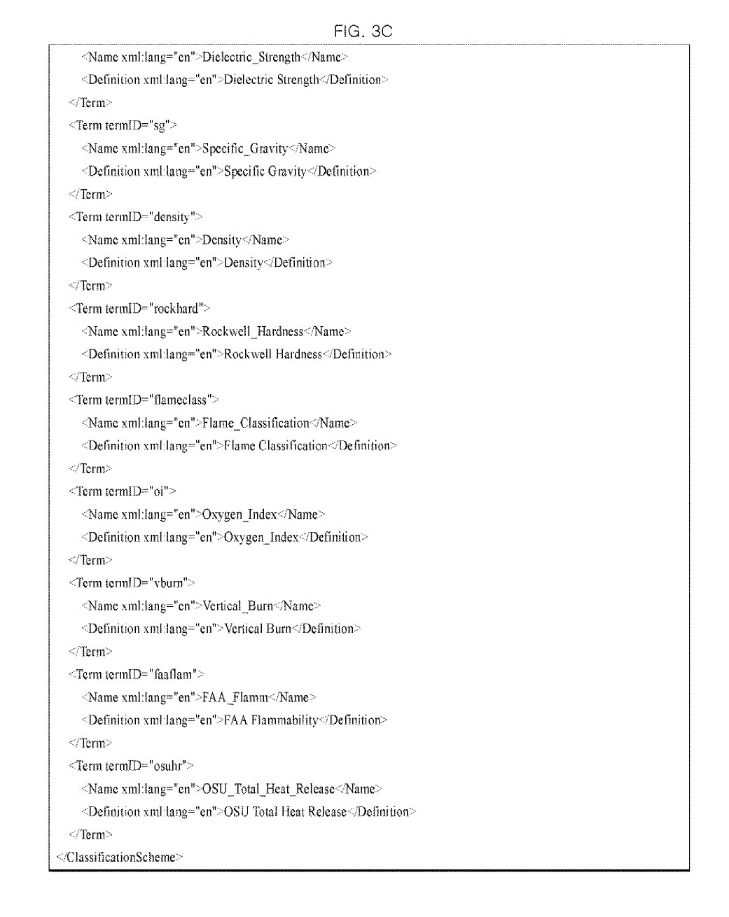

FIG. 3A, FIG. 3B and FIG. 3C illustrate CS (classification scheme) specifying printing material characteristic information which is used to print a 3D object.

In an embodiment of the present invention, the material type information may include name of a material.

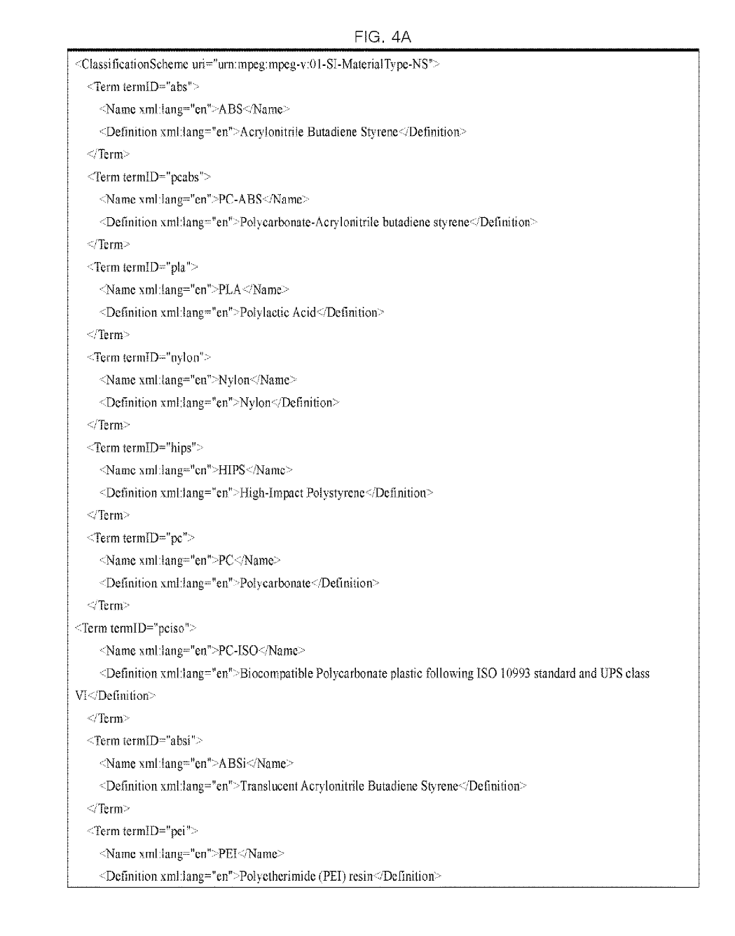

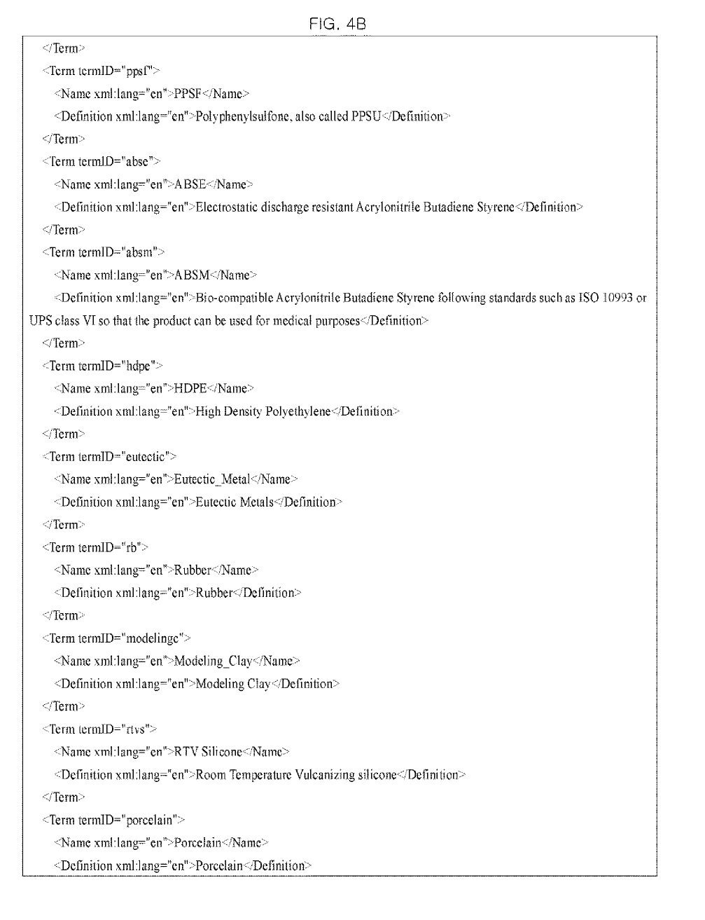

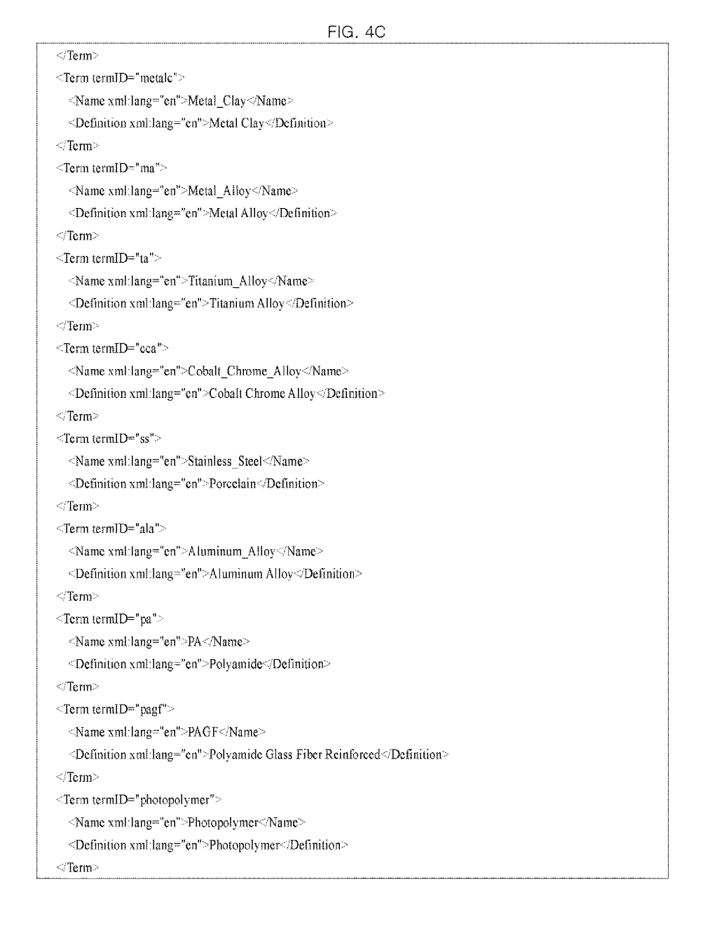

FIG. 4A, FIG. 4B, FIG. 4C and FIG. 4D illustrate CS (classification scheme) specifying material type information which is used to print a 3D object. Referring to FIG. 4(a) to FIG. 4(d), it is noted that various material types including acrylonitrile butadiene styrene (ABS), polycarbonate-acrylonitrile butadiene styrene (PC-ABS), polylactic acid (PLA) and nylon, etc. are defined. However, they are not limited thereto.

A user may set preference information to be used for 3D printing by referring to material characteristic information and material type information of the 3D model.

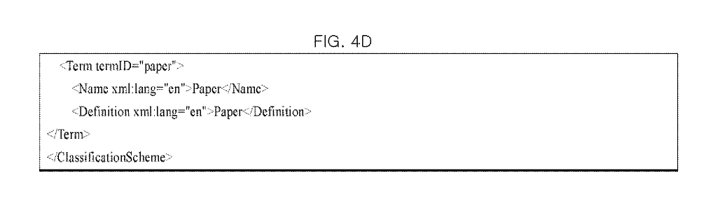

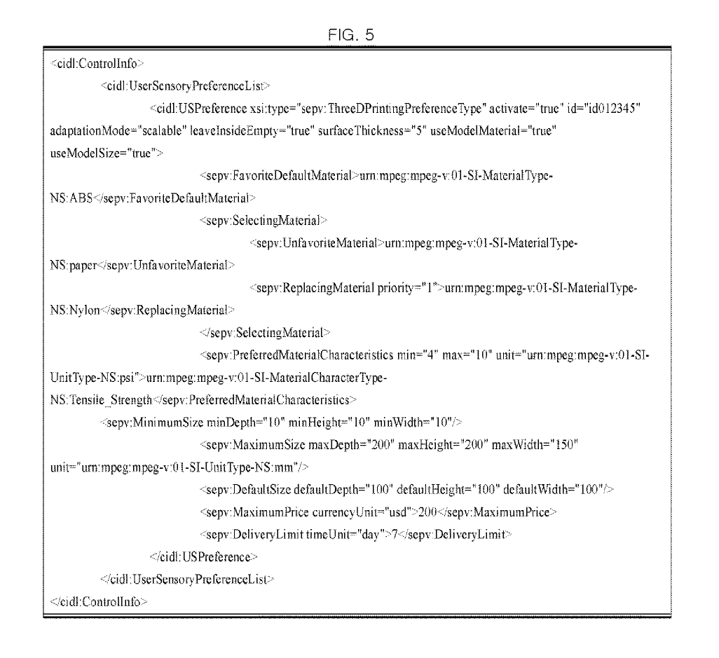

FIG. 5 illustrates preference information written in the XML format according to an embodiment of the present invention.

The preference information in FIG. 5 shows that the surface thickness of the 3D object is 5 and material and size information defined in metadata of the 3D model are used. It also shows that ABS is used as a preference printing material, paper is used as an unfavorite printing material, and nylon is used as a replacing printing material.

The preference information also shows minimum value (4 psi) and maximum value (10 psi) of physical properties, characteristics of a preference printing material (tensile strength), depth (10 mm)/height (10 mm)/width (10 mm) among minimum printing sizes which a user wants, depth (200 mm)/height (200 mm)/width (150 mm) among maximum printing sizes which a user wants, depth (100 mm)/height (100 mm)/width (100 mm) among default printing sizes, maximum printing price (200 dollars), and delivery time (7 days).

In an embodiment of the present invention, the printer characteristic information may include at least one information of 3D printer specification, material/color/file supportable by a 3D printer, maximum size of an object that can be printed by a 3D printer, resolution of a 3D printer and accuracy of a 3D printer.

Here, the 3D printer specification may include information about manufacturer, brand name, model, number of printer heads, printing speed and nozzle of the corresponding 3D printer.

The printer characteristic information may be determined by a user or a printer manufacturer.

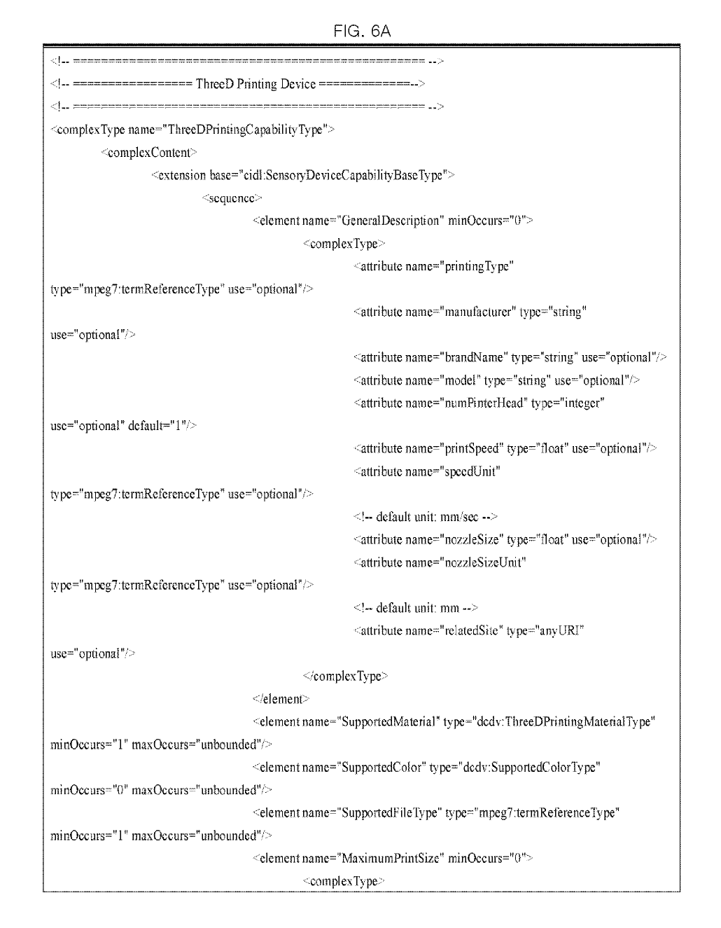

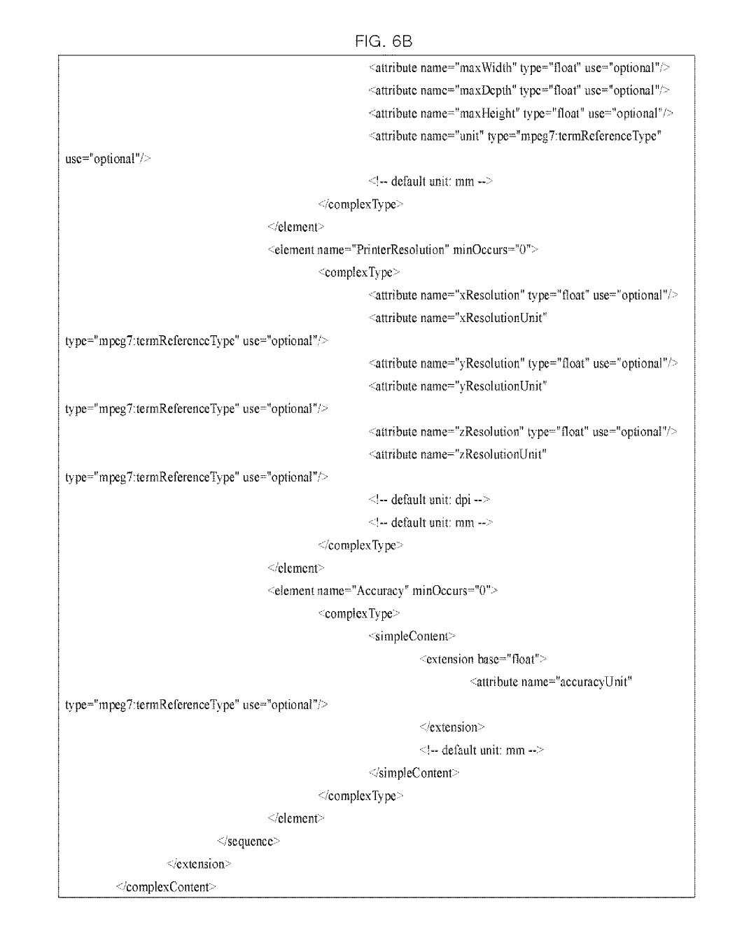

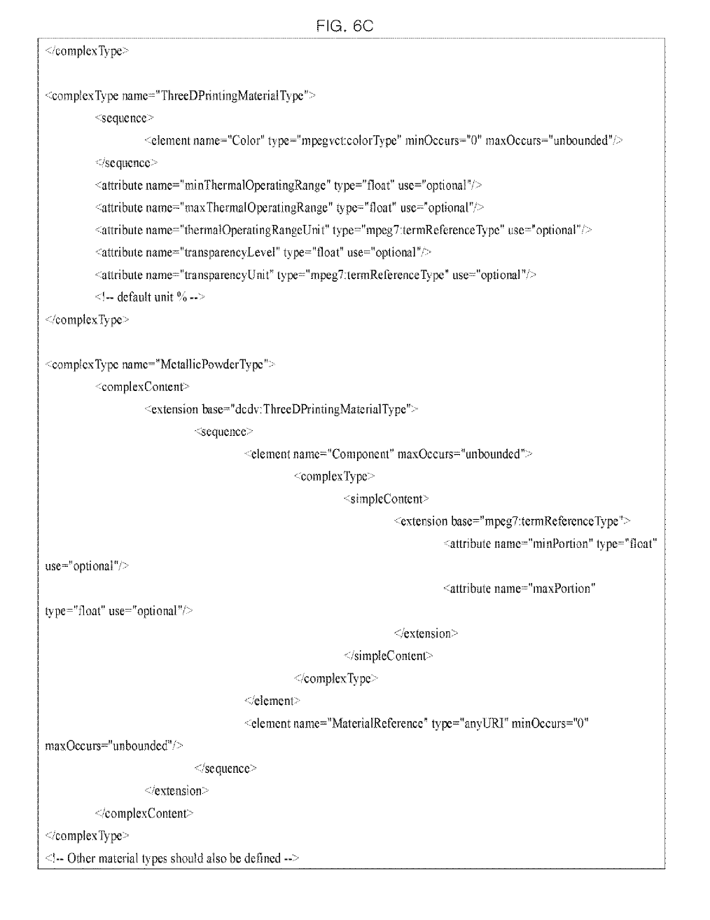

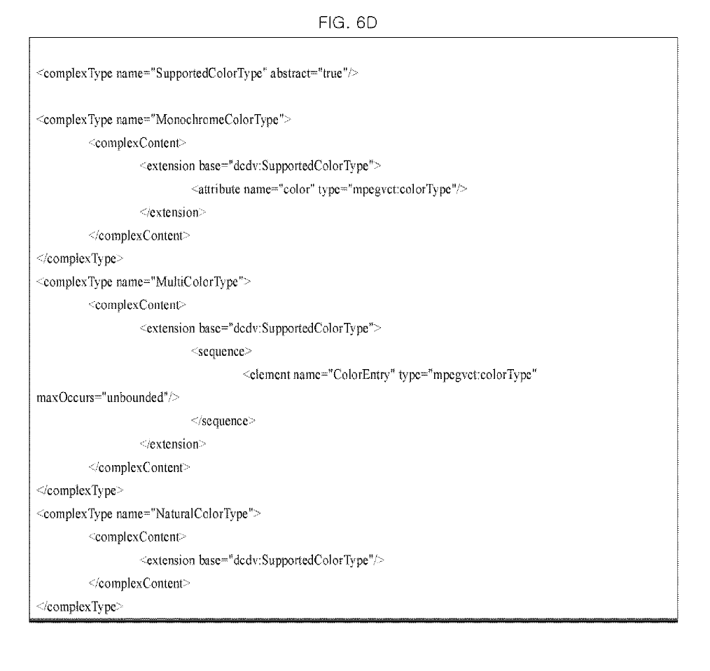

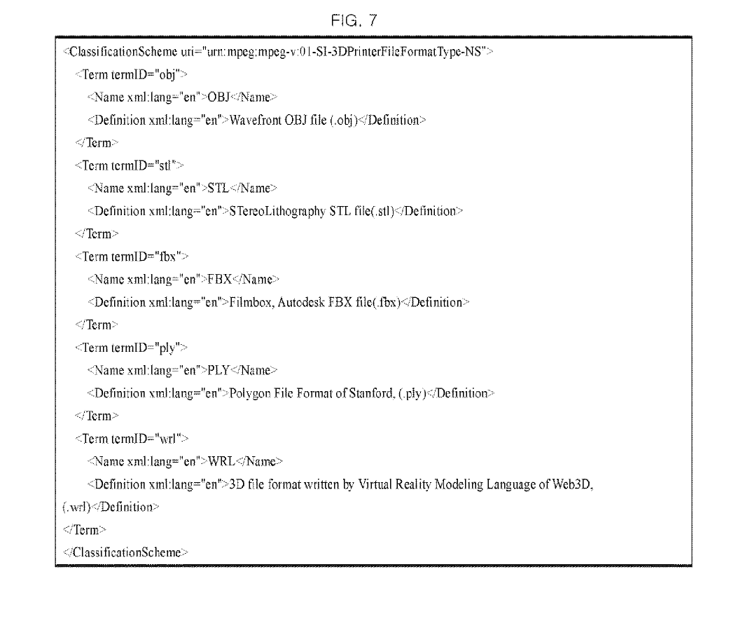

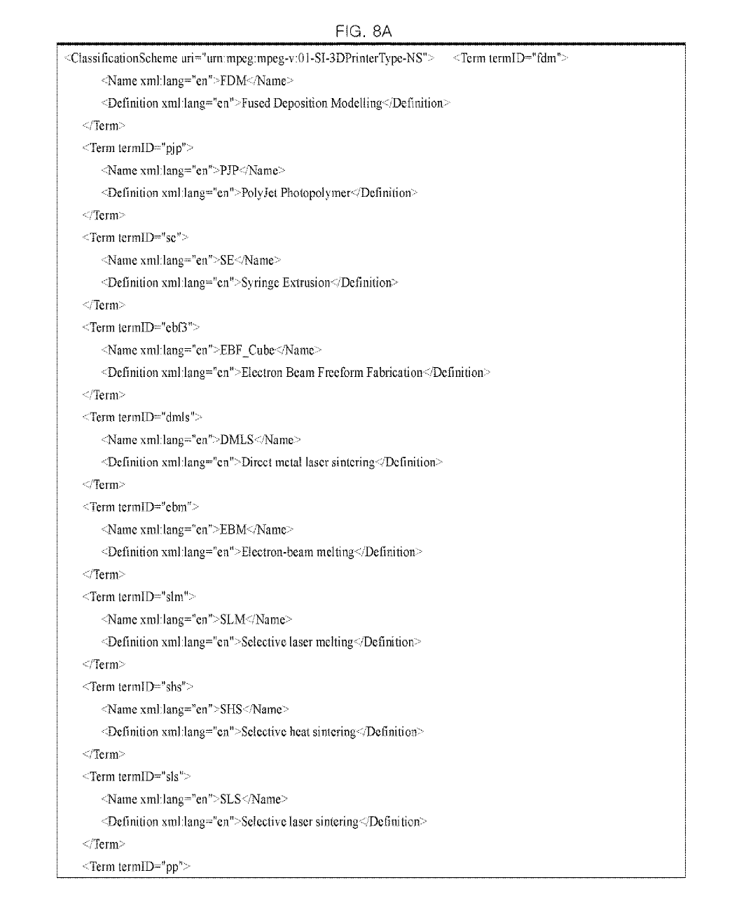

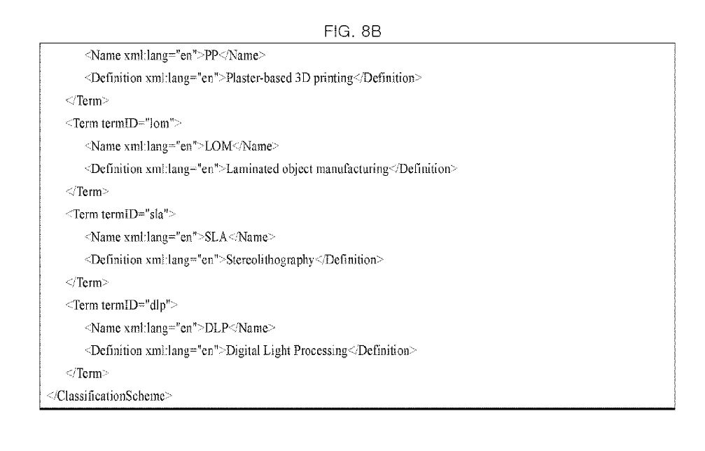

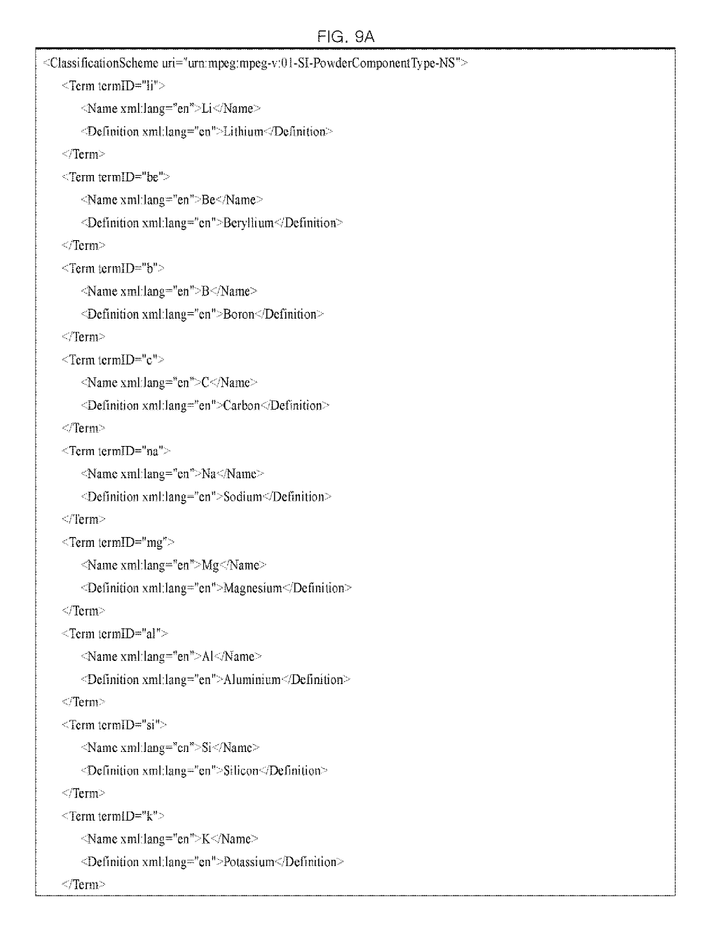

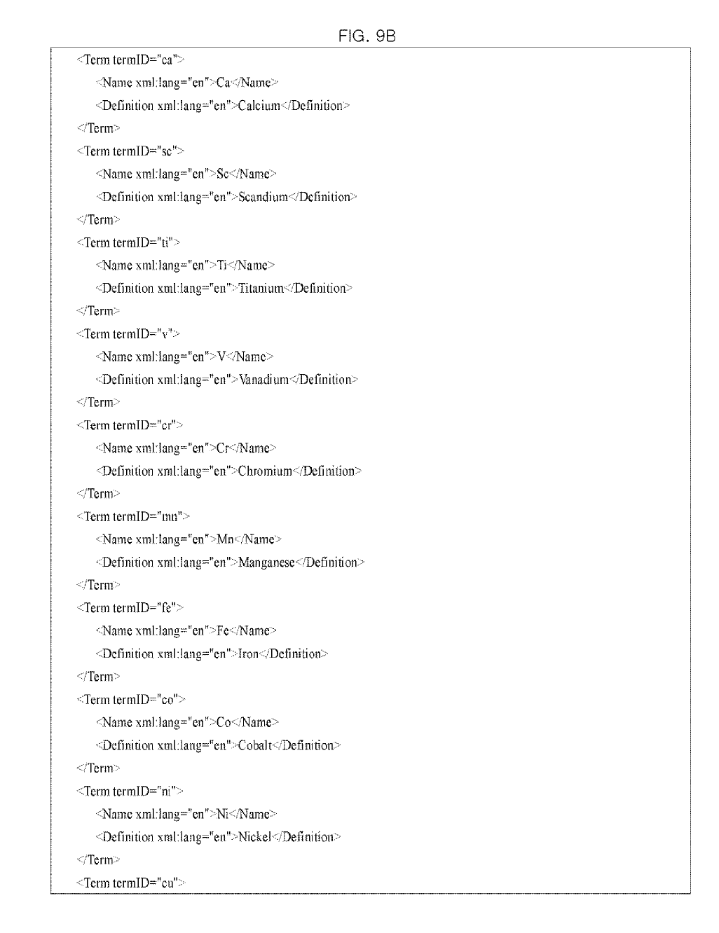

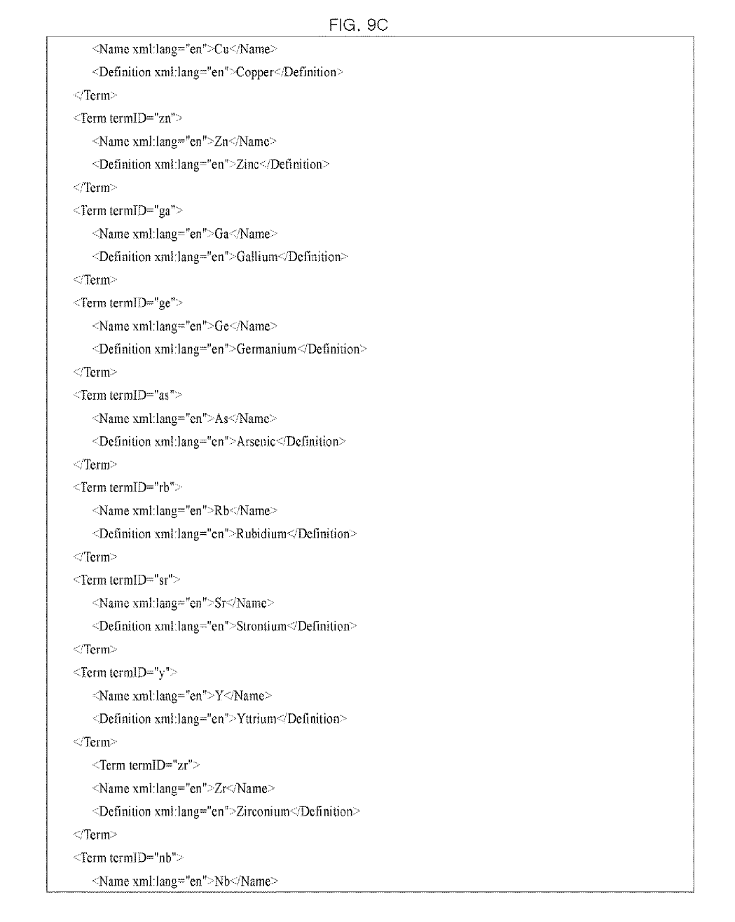

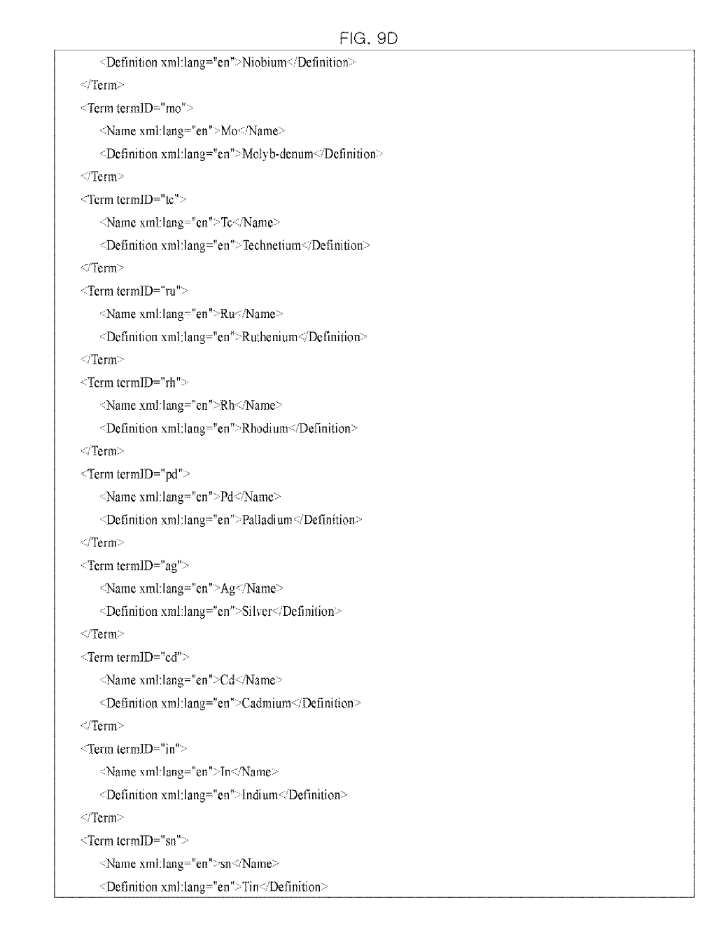

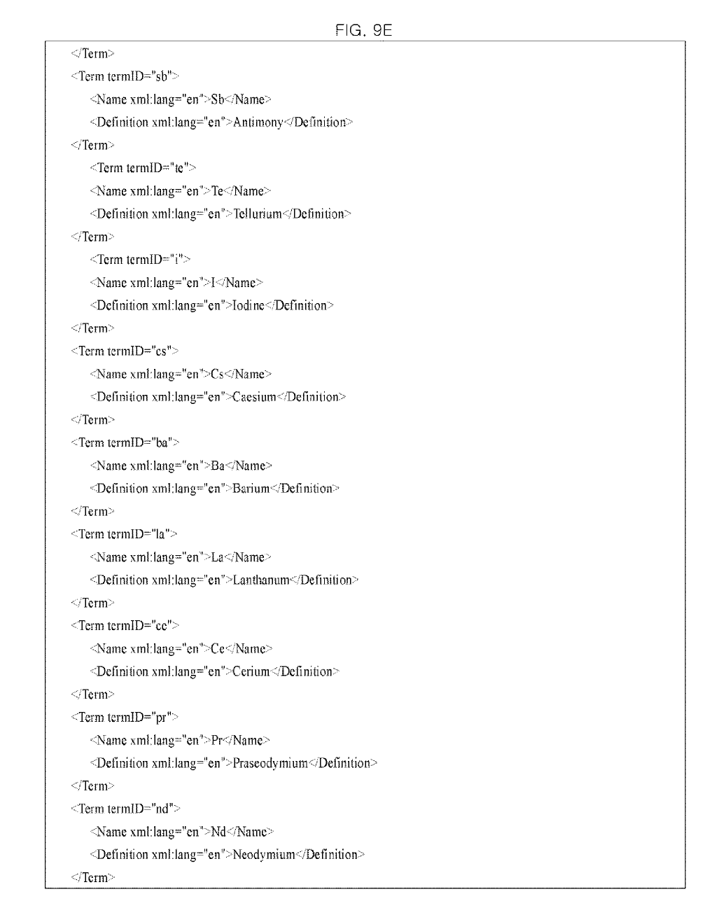

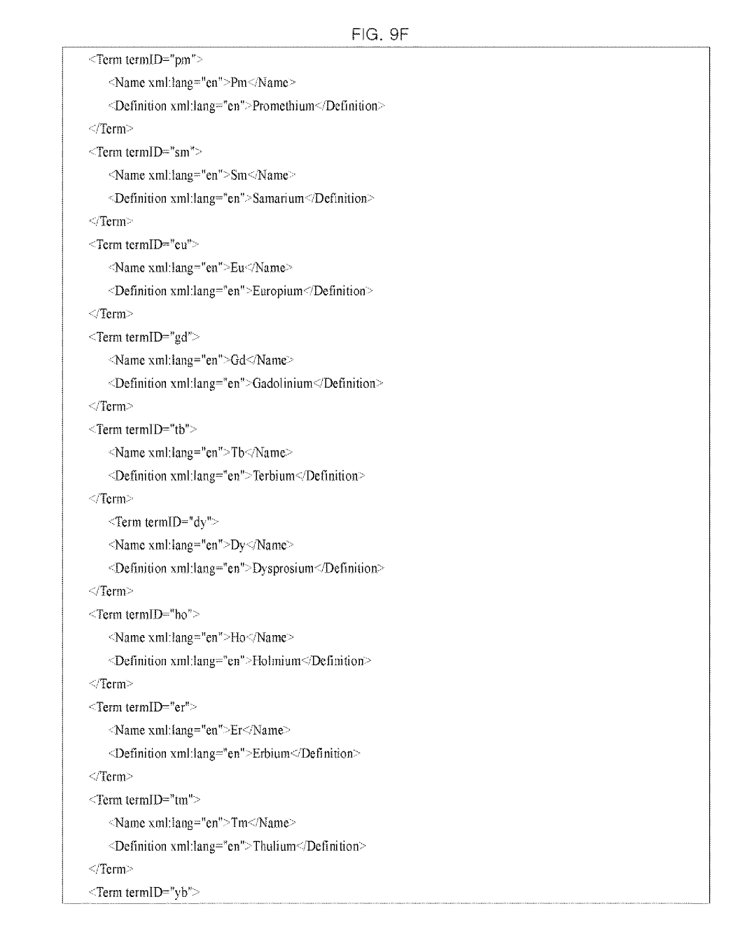

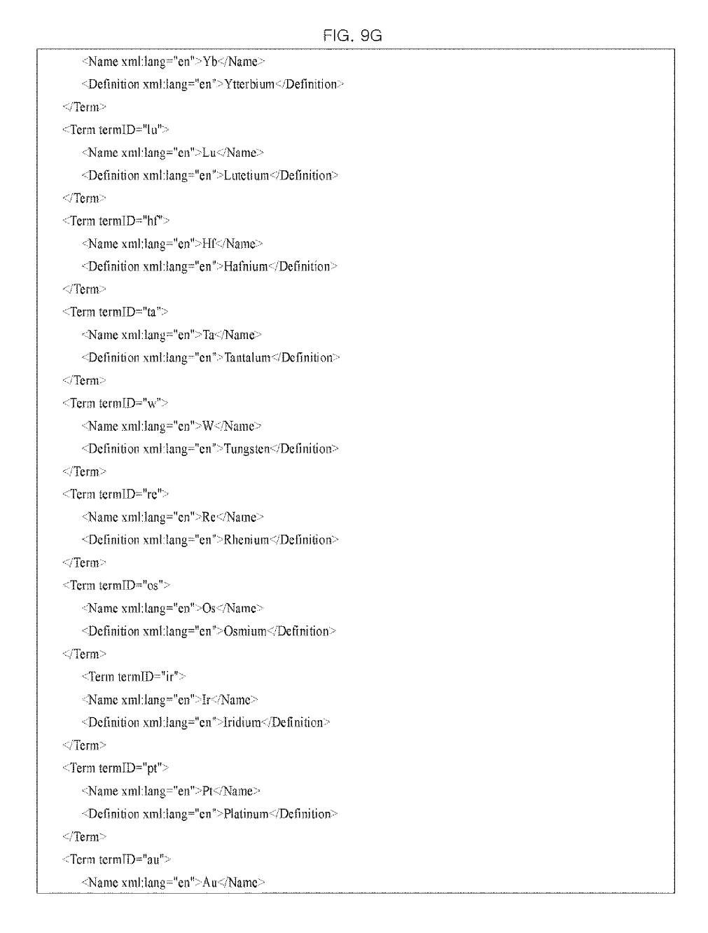

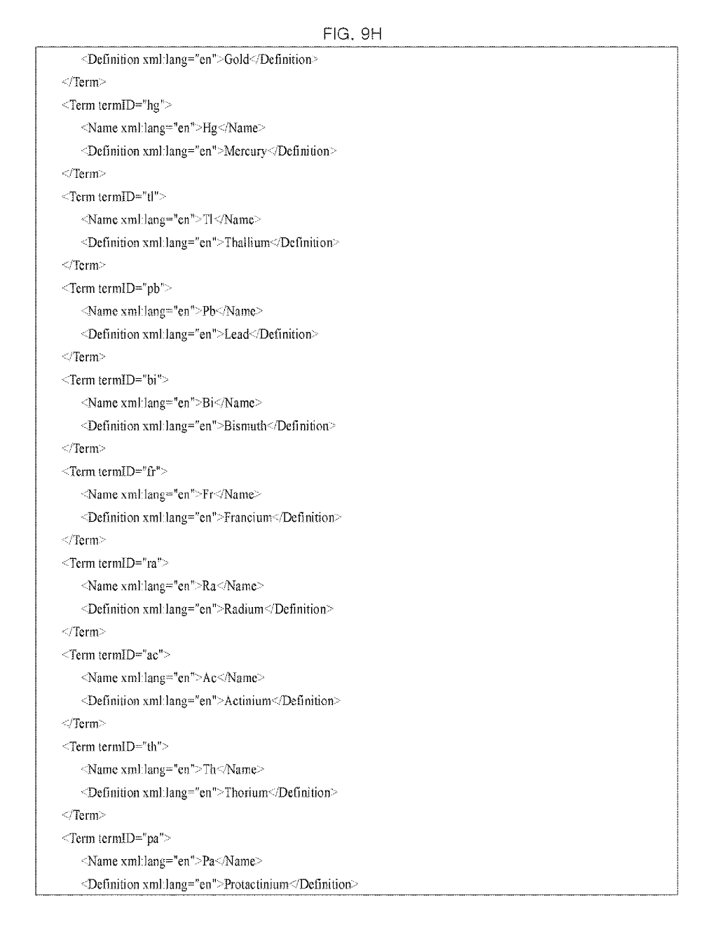

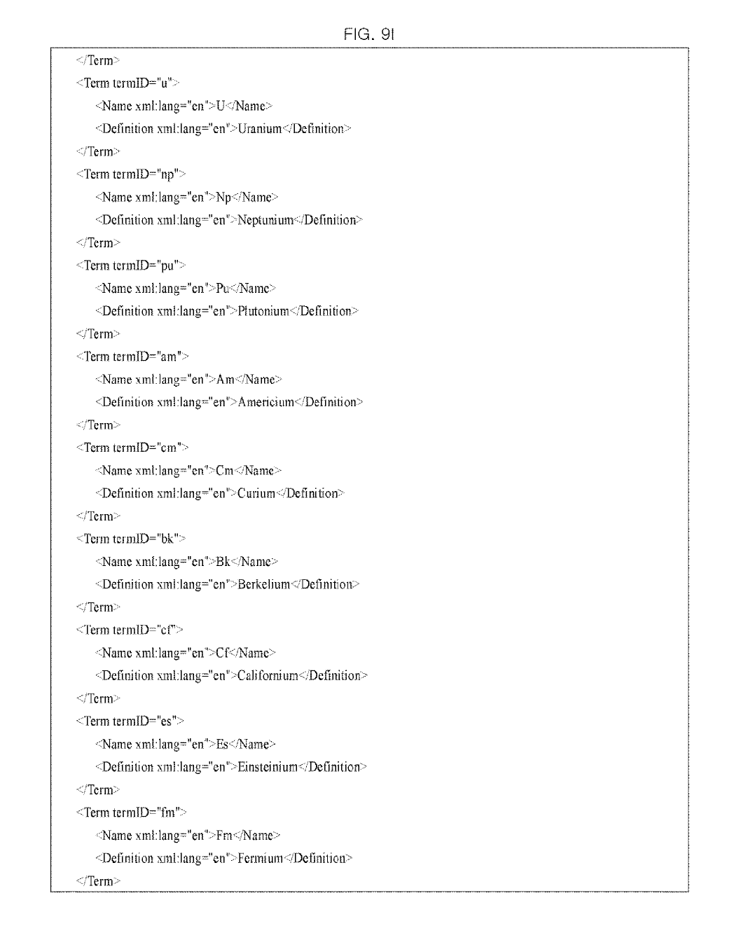

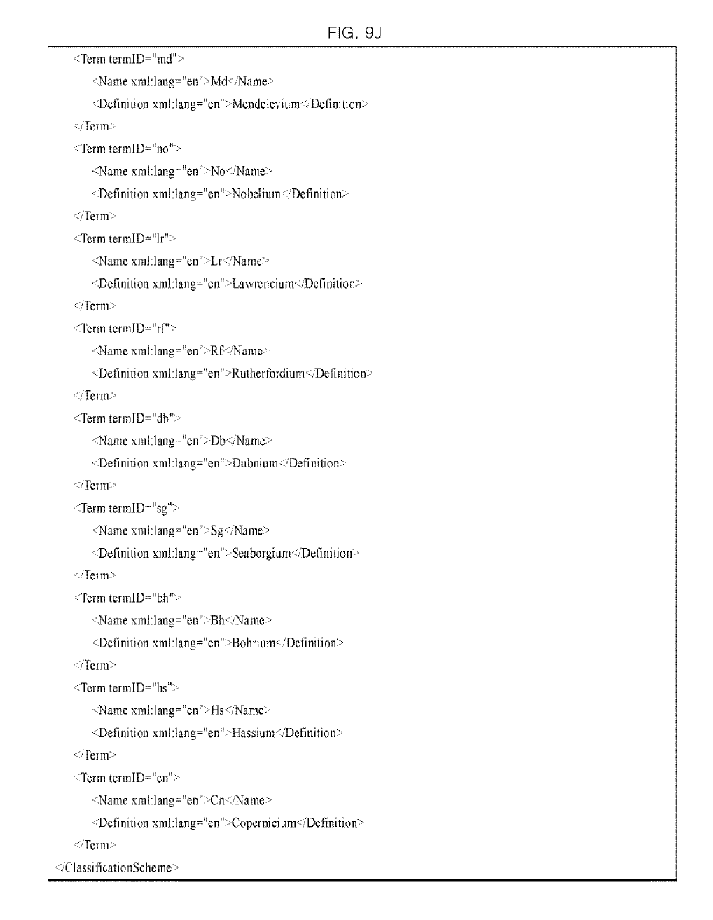

Table 3 to Table 5 are terms related to printer characteristic information and definitions thereof. FIG. 6(a) to FIG. 6(d) illustrate XML schema specifying printer characteristic information defined in Table 3 to Table 5. FIG. 7 illustrates CS (classification scheme) of supported file formats from the 3D printer characteristic information. FIG. 8(a) and FIG. 8(b) illustrate CS (classification scheme) of the printer type. FIG. 9(a) to FIG. 9(j) illustrate CS of specific elements of a powder-typed printing material.

TABLE 3

| Name | Definition |
|---|---|
| ThreeDPrintingCapabilityType | Tool for describing the capability of a 3D printer |
| GeneralDescription | General description of 3D printer characteristics |
| printingType | Type of technologies applied for the 3D printer. |
| | Examples are FDM (Fused Deposition Modeling), |
| | EBF³ (Electron Beam Freeform Fabrication), |
| | DMLS (Direct Metal Laser Sintering). |
| | The printer types are defined in the classification |
| | scheme given at the end of the syntax. |
| manufacturer | Manufacturer of a 3D printer. |
| brandName | Brand name of a 3D printer. |
| | It may be identical to the manufacturer. |
| model | Model of a 3D printer. |
| numPrinterHead | The number of printer heads of a 3D printer. If not |
| | specified, the default value is 1. |
| printSpeed | 3D printing average speed. When it is not defined |
| | by the speedUnit attribute, the default unit of printing |
| | speed is mm/sec. |
| speedUnit | The unit used in specifying the print speed in |
| | printSpeed attribute. |
| | mpeg7: a classification scheme term used in |
| | ISO/IEC 15938-5: 2003 7.6 of termReferenceType. |
| nozzleSize | Nozzle size which is used for a 3D printer. |
| | When it is not defined by the nozzleSizeUnit |
| | attribute, the default unit of the nozzle size is mm. |
| nozzleSizeUnit | The nozzleSize unit. |
| | mpeg7: a classification scheme term used in |
| | ISO/IEC 15938-5: 2003 7.6 of termReferenceType. |
| | If this attribute is not specified, the default unit of |
| | mm (millimeter) is used. |
| relatedSite | Website location which provides information |
| | related to a 3D printer. |
| SupportedMaterial | Printable material by a 3D printer. |
| SupportedColor | Printable color by a 3D printer. |
| SupportedFileType | Printable file type by a 3D printer. |

TABLE 4

| Name | Definition |
|---|---|
| MaximumPrintSize | Maximum size of an object that can be printed by a |
| | 3D printer. |
| maxWidth | Maximum size of the printable object in the |
| | horizontal direction. |
| maxDepth | Maximum size of the printable object in the viewing |
| | direction. |
| maxHeight | Maximum size of the printable object in the vertical |
| | direction. |
| unit | Unif for maxWidth, maxDepth, maxHeight. |
| | mpeg7: a classification scheme term used in |
| | ISO/IEC 15938-5: 2003 7.6 of termReferenceType. |
| | If this attribute is not specified, the default unit of |
| | mm (millimeter) is used. |
| PrinterResolution | Resolution of a 3D printer. |
| | This element specifies the printer resolution in x, y, |
| | and z direction. |
| xResolution | Resolution of the 3D printer in x-axis direction. |
| xResolutionUnit | Resolution unit in x-axis direction. |
| | mpeg7: a classification scheme term used in |
| | ISO/IEC 15938-5: 2003 7.6 of termReferenceType. |
| | If this attribute is not specified, the default unit of |
| | dpi(dots per inch) is used. |
| yResolution | Resolution of the 3D printer in y-axis direction. |
| yResolutionUnit | Resolution unit in y-axis direction. |
| | mpeg7: a classification scheme term used in |
| | ISO/IEC 15938-5: 2003 7.6 of termReferenceType. |
| | If this attribute is not specified, the default unit of |
| | dpi(dots per inch) is used |
| zResolution | Resolution of the 3D printer in z-axis direction. |
| zResolutionUnit | Resolution unit in z-axis direction. |
| | mpeg7: a classification scheme term used in |
| | ISO/IEC 15938-5: 2003 7.6 of termReferenceType. |
| | If this attribute is not specified, the default unit of |
| | dpi(dots per inch) is used |
| Accuracy | Accuracy of a 3D printer. i.e. provides the |
| | capability of the printer. |
| accuracyUnit | Unit of accuracy. |
| | mpeg7: a classification scheme term used in |
| | ISO/IEC 15938-5: 2003 7.6 of termReferenceType. |
| | If this attribute is not specified, the default unit of |
| | mm (millimeter) is used |

TABLE 5

| Name | Definition |
|---|---|
| ThreeDPrintingMaterialType | Default properties of a 3D printing |
| | material. |
| Color | Material color. |
| minThermalOperatingRange | Minimum temperature to print a material. |
| maxThermalOperatingRange | Maximum temperature to print a material. |
| thermalOperatingRangeUnit | Temperature unit. |
| transparency | Material transparency. |
| transparencyUnit | Transparency unit. |
| MetallicPowderType | When a printing material is metallic |
| | powder material. |
| Component | Powder material. |
| minPortion | Minimum portion of component |
| | (percentage) |
| maxPortion | Maximum portion of component |
| | (percentage) |
| MaterialReference | Website which provides additional |
| | information for metallic powder. |
| SupportedColorType | Color supported by a 3D printer. This |
| | attribute is abstract and cannot be |
| | exemplified. |
| MonochromeColorType | When provided by a single color, color. |
| color | Single color RGB. |
| MultiColorType | When provided by multi-colors, color set. |
| ColorEntry | Information of each color. |
| NaturalColorType | When a natural color is supported, |
| | supported color |

FIG. 10 illustrates printer characteristic information written in the XML format according to an embodiment of the present invention.

Referring to FIG. 10, it is noted that the printer characteristic information specifies a manufacturer (My3D), a brand name (Good), a model (Good3D), the number of printer heads (1), a powder-typed material (copper 99.9%), maximum width (14 inches), maximum depth (14 inches) and maximum height (14 inches).

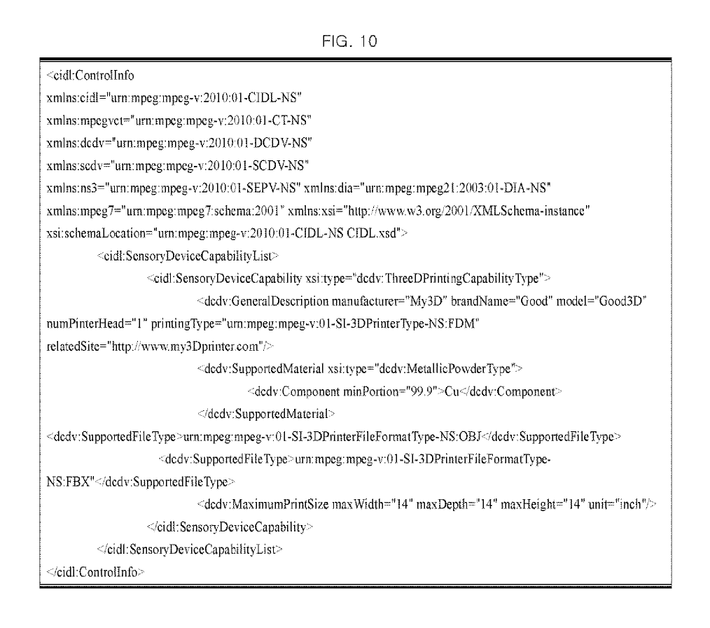

FIG. 11 is a flowchart illustrating a method for recommending a 3D printer according to an embodiment of the present invention. According to embodiments, at least one step among the steps in FIG. 11 may be omitted.

In Step 1101, an apparatus for recommending a 3D printer receives printer characteristic information from a plurality of 3D printers in cloud and also implements database by using the received printer characteristic information.

In Step 1103, the apparatus for recommending a 3D printer receives preference information by a user who wants 3D printing.

In Step 1105, the apparatus for recommending a 3D printer selects a 3D printer which satisfies user's preference information by referring to a pre-established database.

In Step 1107, the apparatus for recommending a 3D printer recommends the selected 3D printer to the user.

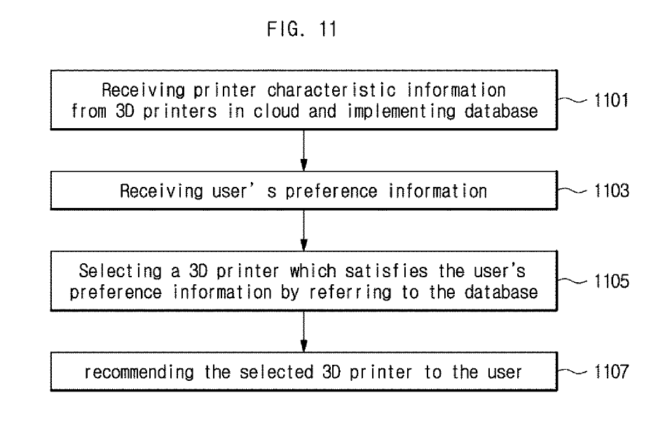

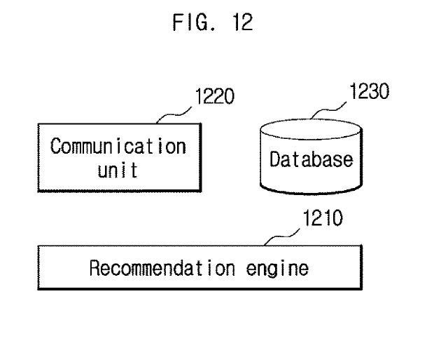

FIG. 12 is a block view illustrating an apparatus for recommending a 3D printer according to an embodiment of the present invention. Referring to FIG. 12, an apparatus for recommending a 3D printer according to an embodiment of the present invention includes a recommendation engine 1210, a communication unit 1220 and a database 1230. According to embodiments, at least a part of the components illustrated in FIG. 12 may be omitted.

The recommendation engine 1210 may determine if there is printer characteristic information which satisfies the preference information received from the user by referring to the pre-established database 1230. When there is printer characteristic information which satisfies the preference information, the recommendation engine 1210 may recommend a 3D printer corresponding to the printer characteristic information to the user.

The communication unit 1220 may perform communication with a plurality of 3D printers in cloud. The communication unit 1220 may transmit printer characteristic information received from the 3D printers to the recommendation engine 1210 or the database 1230. The communication unit 1220 may receive preference information from the user and transmit the received preference information to the recommendation engine 1210. According to embodiments, the preference information may be received with a 3D model.

The database 1230 may store the printer characteristic information received from the 3D printers.

The exemplary embodiment of the present invention can be implemented by various method. For example, the exemplary embodiment of the present invention can be implemented by using hardware, software or its combination. When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A method for configuring information related to a 3D printer comprising:
configuring user's preference information which is used to print a 3D object or select a 3D printer; and
configuring characteristic information of a 3D printer which prints a 3D object.

2. The method for configuring information related to a 3D printer of claim 1, wherein the user's preference information comprises at least one information of printing material, physical properties of a printing material, printing size, printing price, delivery time of a printed result, surface thickness of a printed result, and information whether size and material information included in a 3D model is to be used or not.

3. The method for configuring information related to a 3D printer of claim 1, wherein the printer characteristic information comprises at least one information of 3D printer specification, material/color/file supportable by a 3D printer, maximum size of an object that can be printed by a 3D printer, resolution of a 3D printer and accuracy of a 3D printer.

4. A method for recommending a 3D printer comprising:
receiving user's preference information which is used to print a 3D object;
selecting a 3D printer which satisfies the user's preference information by referring to a database storing characteristic information of at least one 3D printer; and
recommending the selected 3D printer to the user.

5. The method for recommending a 3D printer of claim 4, wherein the user's preference information is received with a 3D model which is used to print the 3D object.

6. The method for recommending a 3D printer of claim 5, wherein the 3D model comprises at least one of size and material information of the 3D object.

7. The method for recommending a 3D printer of claim 6, wherein the material information of the 3D object comprises at least one of material characteristic information and material type information.

8. The method for recommending a 3D printer of claim 7, wherein the material characteristic information comprises at least one information of tensile, flexural strength, Izod, compression, shear, temperature, volume resistance, dielectricity, dissipation factor, specific gravity, density and hardness.

9. The method for recommending a 3D printer of claim 4, wherein the user preference information comprises at least one information of printing material, physical properties of a printing material, printing size, printing price, delivery time of a printed result, surface thickness of a printed result, and information whether size and material information included in a 3D model is to be used or not.

10. The method for recommending a 3D printer of claim 9, wherein the 3D model comprises at least one of size and material information of the 3D object, and
if the user preference information indicates not to use the size and material information included in the 3D model, size and material information included in the user preference information is used when the 3D printer is selected.

11. The method for recommending a 3D printer of claim 9, wherein the 3D model comprises at least one of size and material information of the 3D object, and
if the user preference information indicates to use the size and material information included in the 3D model, size and material information included in the 3D model is used when the 3D printer is selected.

12. The method for recommending a 3D printer of claim 4, wherein the printer characteristic information comprises at least one information of 3D printer specification, material/color/file supportable by a 3D printer, maximum size of an object that can be printed by a 3D printer, resolution of a 3D printer and accuracy of a 3D printer.

13. An apparatus for recommending a 3D printer comprising:
a communication unit configured to receive user's preference information which is used to print a 3D object;
a database configured to store characteristic information of at least one 3D printer; and
a recommendation engine configured to select a 3D printer which satisfies the user's preference information by referring to the database and recommending the selected 3D printer to the user.

14. The apparatus for recommending a 3D printer of claim 13, wherein a 3D model which is used to print the 3D object comprises at least one of size and material information of the 3D object.

15. The apparatus for recommending a 3D printer of claim 14, wherein the material information of the 3D object comprises at least one of material characteristic information and material type information.

16. The apparatus for recommending a 3D printer of claim 15, wherein the material characteristic information comprises at least one information of tensile, flexural strength, Izod, compression, shear, temperature, volume resistance, dielectricity, dissipation factor, specific gravity, density and hardness.

17. The apparatus for recommending a 3D printer of claim 13, wherein the user preference information comprises at least one information of printing material, physical properties of a printing material, printing size, printing price, delivery time of a printed result, surface thickness of a printed result, and information whether size and material information included in a 3D model is to be used or not.

18. The apparatus for recommending a 3D printer of claim 17, wherein the 3D model comprises at least one of size and material information of the 3D object, and
the recommendation engine selects the 3D printer by referring to the size and material information included in the user preference information when the user preference information indicates not to use the size and material information included in the 3D model.

19. The apparatus for recommending a 3D printer of claim 17, wherein the 3D model comprises at least one of size and material information of the 3D object, and
the recommendation engine selects the 3D printer by referring to the size and material information included in the 3D model when the user preference information indicates to use the size and material information included in the 3D model.

20. The apparatus for recommending a 3D printer of claim 13, wherein the printer characteristic information comprises at least one information of 3D printer specification, material/color/file supportable by a 3D printer, maximum size of an object that can be printed by a 3D printer, resolution of a 3D printer and accuracy of a 3D printer.
